(19) United States
(12) Patent Application Publication
(10) Pub. No.: US 2003/0022744 A1
(43) Pub. Date: Jan. 30, 2003

(54) Front gear-change device for bicycle

(75) Inventors: Ming-Chin Tsai, Taipei (TW); Jie-Ming Tsai, FangYuan City (TW)

Correspondence Address: DOUGHERTY & TROXELL, SUITE 1404, 5205 LEESBURG PIKE, FALLS CHURCH, VA, 22041, US

(73) Assignee: SunRace Roots Enterprise Co., Ltd.

(21) Appl. No.: 09/915,309

(22) Filed: Jul. 27, 2001

(51) Int. Cl. F16H 9/00; F16H 63/00

(52) U.S. Cl. 474/80; 474/82

(57) ABSTRACT

An improved front gear-change device for bicycle, which features are: one side of a inner guide rod is set a cable guide for guiding speed-change cable, and the inner guide rod, the cable guide, a body and an outer guide rod are all made of plastic; there is a metal spacer on upper rim of inner guide rod for protection between a fine tuning screw, a fixing screw and inner guide rod, thus inner guide rod can avoid damage; the body is set plural tool holes for carry-on tools. The plastic part of the improved front gear-change device is made by direct inject molding, no additional machining.

### 1. FIELD OF THE INVENTION

The present invention is an improved front gear-change device for bicycle, especially the body of the gear-change device is made of plastic, and it is designed for carrying tools.

### 2. BACKGROUND OF THE INVENTION

The science is getting well, the gear-change levels is also increasing. There were only four, five and six gear-change levels of rear gear-change device at old days; and now there are twelve or even fifteen gear-change levels of front gear-change device. Thus, how to be increasing life, more fluent gear-change and lighter weight for relax ridding are the developing points.

The front gear-change device is made of metal, and it is hard to machining and also heavier weight, so the cost is higher. After being used for a while, an anti-rust layer on surface is stripped, and inner of the device is getting rust, certainly life is shorter. There are some problems happened when people riding bike, for example, out of chain, gear-change device not working properly, slack fasteners, etc. Those problems must be solved by tools, such as hex wrench, screwdriver, etc. Normally, there is no function of carrying tools for bicycle, thus, the only way is handy moving.

### BRIEF DESCRIPTION OF THE INVENTION

The main object of the present invention is to offer an improved front gear-change device for bicycle, which is made of plastic for lighter weight, long life and low cost.

The second object of the present invention is to offer an improved front gear-change device for bicycle, which is easily manufactured by direct-form.

The third object of the present invention is to offer an improved front gear-change device for bicycle, which is set plural tool holes for carry-on tools.

To reach the above objects, an improved front gear-change device for bicycle is produced, which consists of a body, it is with a fixing portion for connecting with a body frame of bicycle; a chain guide, it is for accommodating a chain, and the chain can work with the chain guide; an outer guide rod and an inner guide rod, they are for connection of the body and the chain guide, thus a parallel moving mechanism organized by the outer guide rod and the inner guide rod drives chain guide to shift chain to different sizes of gears for gear-change; a fine tuning screw and a fixing screw, which are going through body for adjusting and fixing the beginning parallel position of inner guide rod, and the feature is that there is a cable guide on one side of inner guide rod for guiding cable, further, inner guide rod, cable guide, body and outer guide rod are made of plastic. There is a metal spacer on upper rim of inner guide rod for protection between the fine tuning screw, the fixing screw and inner guide rod, thus inner guide rod can avoid damage. There are plural tool holes on body for carry-on tools. The plastic part of the improved front gear-change device is made by direct inject molding, no additional machining.

For further understanding the present invention, please refer to the following figures, description:

### BRIEF DESCRIPTION OF THE DRAWINGS

FIG. 1 is the top view of the preferred embodiment of the present invention.

FIG. 2 is the sectional side view of the preferred embodiment of the present invention.

FIG. 3 is the scheme of operation of the present invention.

FIG. 4 is the scheme of carry-on tools of the present invention.

### DETAILED DESCRIPTION OF THE PREFERRED EMBODIMENT

The present invention is an improved front gear-change device for bicycle, which body is made of plastic for lighter weight, long life and low cost, and the body is made by direct inject molding. There are plural tool holes set on body for carry-on tools.

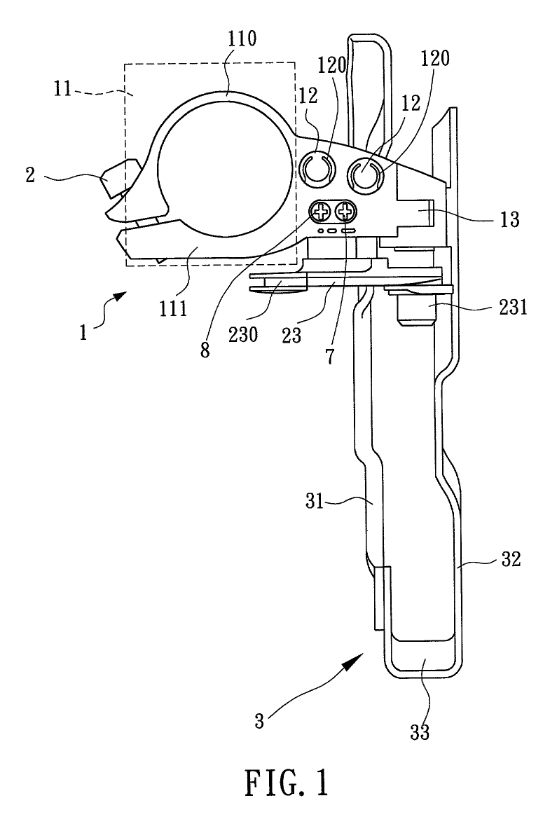

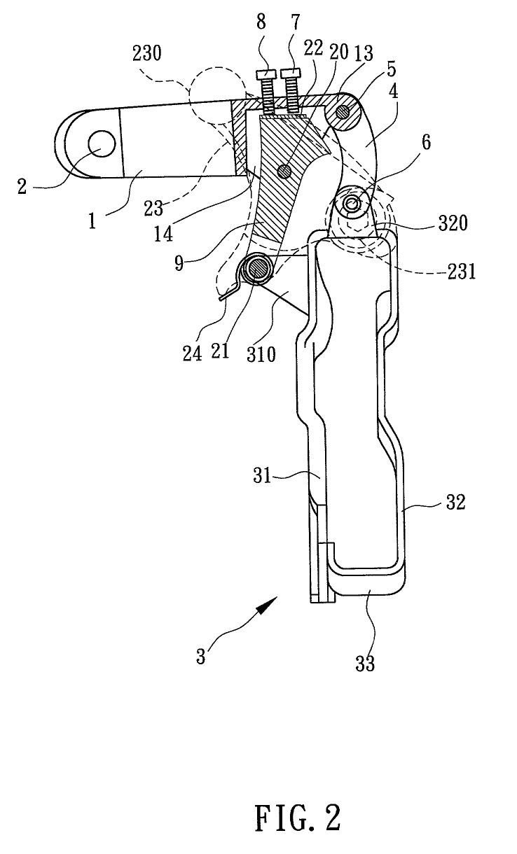

FIG. 1 and FIG. 2 are the top view of the preferred embodiment of the present invention and the sectional side view of the preferred embodiment of the present invention. As shown in FIGS. 1 and 2, an improved front gear-change device for bicycle consists of: a body 1, which is with a fixing portion 11, hollow shape formed by two clamping portions of a first clamping portion 110 and a second clamping portion 111, for connecting with a body frame (not shown in figure) of bicycle, and then a fixing screw 2 going through for fixing, body 1 is set tool holes 12 for carry-on tools, an outer guide rod connector 13 and an inner guide rod connector 14; a chain guide 3, which shape is as “U” letter, and consists of an inner chain guide 31, an outer chain guide 32 and a connector 33, the chain guide 3 is for holding a chain (not shown in figure), and the chain is driven via moving back and forth of the inner chain guide 31 and the outer chain guide 32, the connector 33 prevents the chain going out and makes the chain and chain guide 3 moving together; an outer guide rod 4, which one end connects to the outer guide rod connector 13 via a first pivot 5, and another end connects to an outer connector 320 extended from outer chain guide 32 via a second pivot 6; a fine tuning screw 7 and a fixing screw 8, which are going through body 1 for adjusting and fixing the beginning parallel position of inner guide rod 9; an inner guide rod 9, which one end connects to inner guide rod connector 14 via a third pivot 20, and another end connects to an inner connector 310 extended from inner chain guide 31, there is a metal spacer 22 on upper rim of inner guide rod 9 for protection between the fine tuning screw 7, the fixing screw 8 and inner guide rod 9, thus inner guide rod 9 can avoid damage; a cable guide 23 positioned on out side of inner guide rod 9, which consists of a cable guide slot 230 and a cable lock screw 231 for different types of cable tensions, when installing on a pull-down frame, speed-change cable (not shown in figure) goes through the cable guide slot 230 and extends along cable guide 23, thus it is fixed by the cable lock screw 231; when installing on a drawing frame, speed-change cable is locked by cable lock screw 231 directly. Body 1, outer guide rod 4, inner guide rod 9 and cable guide 23 are made of plastic, so there is the metal spacer 22 on upper rim of inner guide rod 9 for avoiding inner guide rod 9 damaged. The tool holes 12 for carry-on tools are utilized the features of clamping ribs 120 on two sides and flexibility of plastic material to clamp carry-on tools (not shown in figure). The first pivot 5, the second pivot 6, the third pivot 20 and the fourth pivot 21 are organized a four-link mechanism. Using the four-link mechanism, outer guide rod 4 and inner guide rod 9 to form a parallel moving mechanism to drive chain guide 3 to shift chain to different sizes of gears (not shown in figure) for gear-change. A return spring 24 is set on outer rim of fourth pivot 21 for cable guide 23 going back to original position.

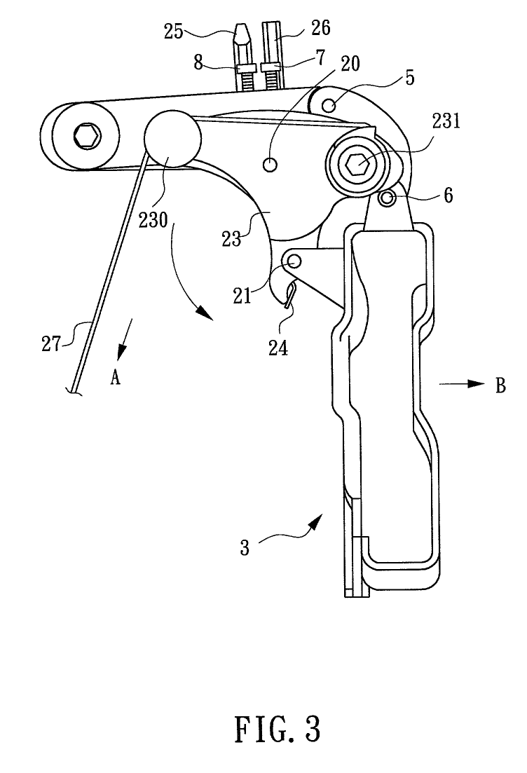

FIG. 3 is the scheme of operation of the present invention. A hex wrench 25 and a screw driver 26 are put into tool holes 12 (shown as in FIG. 1). The clamping ribs 120 (shown as in FIG. 1) in tool holes 12 clamp the hex wrench 25 and the screw driver 26. Because plastic material of clamping ribs 120 is with flexibility, carry-on tools can be clamped without slack. A speed-change cable 27 goes through the cable guide slot 230 and extends along cable guide 23, then it is fixed by cable lock screw 231. When the speed-change cable 27 moving to A direction, cable guide 23 is driven, thus driving chain guide 3 to move toward B direction via the four-link mechanism of first pivot 5, second pivot 6, third pivot 20 and fourth pivot 21 for gear-change purpose; or speed-change cable 27 is directly locked on cable lock screw 231, and moving toward B direction.

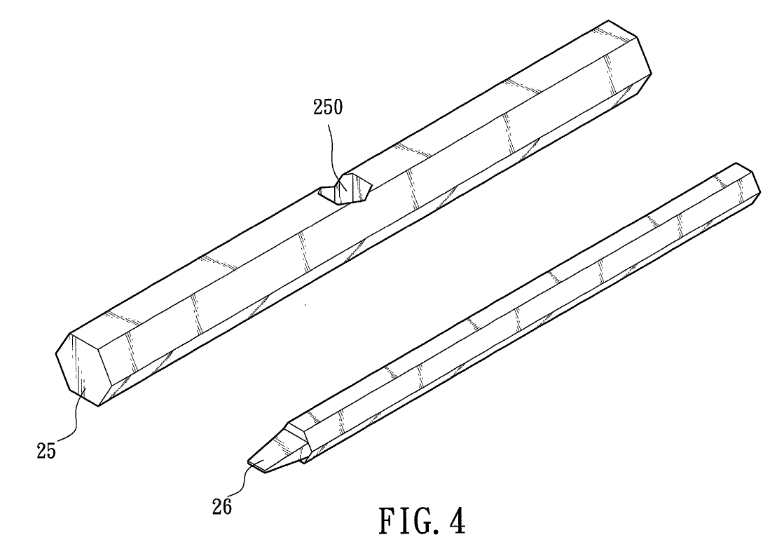

FIG. 4 is the scheme of carry-on tools of the present invention. When riding bicycle, front gear-change device is slack because of loose cable lock screw 231 and being used for a while, thus the gear-change device is inconvenient for operation. Meantime, screw driver 26 matches with a matching hole 250 on hex wrench 25, thus the appearance after matching is as “T” shape, and screw driver 26 is as a handle and hex wrench 25 is used to adjust cable lock screw 231 (shown as in FIG. 4) for changing the tension of speed-change cable 27. After adjustment, the front gear-change device is back to fluent operation. On the other hand, the hex wrench 25 can be as a handle in case of using screw driver 26 to adjust.

The front gear-change device for bicycle of the present invention, wherein, outer guide rod, inner guide rod, cable guide and body are made of plastic with direct inject molding, no additional machining, thus the cost is lower and the competition is higher. Also, plastic material makes lighter weight of bicycle. On the contrary, metal material in prior art has a rust problem; the present invention uses the anti-rust material—plastic, further, without complicate machining process and suitable for any kind of weather, thus the life can be last for a long time. There are plural tool holes on body for carry-on tools, which can be made during direct inject molding, and without any difficulty to make.

The above descriptions are the preferable embodiments of the present invention. The covered scopes of the present invention are not restricted on the embodiments shown in the present invention. All the changes according to the contents of the present invention, such as: the change of shapes or locations of the arrangement of the fastening structures, etc., the generated functions and characteristics similar to those of the embodiments of the present invention and any ideas thought by the persons well-known such technologies are all within the scopes of the present invention.

What is claimed is:

1. An improved front gear-change device for bicycle, which consists of:
a body, which includes a fixing portion for connecting to a body frame of bicycle;
a chain guide, which holds a chain, and the chain guide moves with the chain;
an outer guide rod and an inner guide rod, which are for connection of the body and the chain guide, thus a parallel moving mechanism organized by the outer guide rod and the inner guide rod drives chain guide to shift chain to different sizes of gears for gear-change;
a fine tuning screw and a fixing screw, which are going through body for adjusting and fixing the beginning parallel position of inner guide rod;
the feature is that inner guide rod, cable guide, body and outer guide rod are made of plastic, there is a metal spacer on upper rim of inner guide rod for protection between the fine tuning screw, the fixing screw and inner guide rod, thus inner guide rod can avoid damage, there are plural tool holes on body for carry-on tools.

2. The improved front gear-change device for bicycle as cited in claim 1, wherein, the fixing portion is hollow shape formed by two clamping portions of a first clamping portion and a second clamping portion.

3. The improved front gear-change device for bicycle as cited in claim 2, wherein, there are two holes set on each front end of the two clamping portions for a lock screw going through to fix.

4. The improved front gear-change device for bicycle as cited in claim 1, wherein, there is a cable guide on one side of inner guide rod for guiding cable, and the cable guide is made of plastic.

5. The improved front gear-change device for bicycle as cited in claim 1, wherein, the tool holes further includes plural clamping ribs for clamping carry-on tools.

6. The improved front gear-change device for bicycle as cited in claim 1, wherein, the carry-on tools is hex wrench.

7. The improved front gear-change device for bicycle as cited in claim 1, wherein, the carry-on tools is screw driver.

8. The improved front gear-change device for bicycle as cited in claim 4, wherein, the cable guide includes a cable guide slot and a cable lock screw; a speed-change cable goes through the cable guide slot and extends along cable guide, thus it is fixed by the cable lock screw.

9. The improved front gear-change device for bicycle as cited in claim 1, wherein, body includes an outer guide rod connector and an inner guide rod connector.

10. The improved front gear-change device for bicycle as cited in claim 9, wherein, the chain guide which shape is as “U” letter, and consists of an inner chain guide, an outer chain guide and a connector.

11. The improved front gear-change device for bicycle as cited in claim 10, wherein, an inner connector is extended from the inner chain guide, and an outer connector is extended from the outer chain guide.

12. The improved front gear-change device for bicycle as cited in claim 11, wherein, one end of the outer guide rod connects to the outer guide rod connector via a first pivot, and the other end connects to the outer connector via a second pivot.

13. The improved front gear-change device for bicycle as cited in claim 11, wherein, one end of the inner guide rod connects to the inner guide rod connector via a third pivot, and the other end connects to the inner connector via a fourth pivot.

14. The improved front gear-change device for bicycle as cited in claim 13, wherein, a return spring is set on outer rim of the fourth pivot.
